(19) United States
(12) Patent Application Publication
(10) Pub. No.: US 2019/0263957 A1
(43) Pub. Date: Aug. 29, 2019

(54) HARD CLEAR PROTECTIVE PAINT COATING

(71) Applicant: APNT LLC, Brooklyn, NY (US)

(72) Inventor: Jason BROWN, Brooklyn, NY (US)

(21) Appl. No.: 16/282,974

(22) Filed: Feb. 22, 2019

Related U.S. Application Data
(60) Provisional application No. 62/634,551, filed on Feb. 23, 2018.
(60) Provisional application No. 62/699,278, filed on Jul. 17, 2018.

(51) Int. Cl. C08G 18/02; C08G 18/09; C08G 18/79; C08G 18/18; C08G 18/28; C08G 18/72; C09D 175/04; C08K 5/00

(52) U.S. Cl. CPC C08G 18/022; C08G 18/092; C08G 18/792; C08G 18/1875; C08K 5/005; C08G 18/725; C08G 18/724; C08G 18/722; C09D 175/04; C08G 18/2825

(57) ABSTRACT

A coating composition consisting essentially of one or more aliphatic or aromatic polyisocyanates, or combinations thereof, one or more catalysts, and one or more solvents. The composition is capable of forming a hard clear protective paint coating when applied to a surface, and the polyisocyanate is allowed to react with ambient moisture. A method for applying the coating comprising filtering compressed air to reduce moisture and impurities and then applying the coating composition to a painted surface using the filtered compressed air.

### CROSS-REFERENCE TO RELATED APPLICATIONS

The present application claims the benefit of priority to U.S. Patent Application Ser. No. 62/634,551 filed on Feb. 23, 2018 and U.S. Patent Application Ser. No. 62/699,278 filed on Jul. 17, 2018, the entire disclosures of which are incorporated herein by reference.

### FIELD OF THE DISCLOSURE

The present application relates to the use of protective paint coatings to prevent deep scarring and scratching of painted surfaces while retaining a glossy and non-yellowing appearance.

### BACKGROUND INFORMATION

Some objects have such a refined substrate and/or a paint surface that is nearly flawless, and meets such exact standards, that any damage to the surface detracts from the product. As a result, the retention of value, or opportunity for increased value, can be jeopardized if the painted surface or underlying substrate is damaged. Even the slightest damage can have a large impact on nearly flawless surfaces and becomes more obvious because it stands in stark contrast to the remaining flawless surfaces, and thus renders the surface destroyed. The integrity of the object depends on the condition of the surface remaining intact as produced, and maintaining continuity by always looking new.

Thus, there may be a need to protect painted surfaces from scarring and scratching from, for example, fingernails, clothing, vandalism, impacts, transport, cleaning, or handling. There is no available protective coating for painted surfaces that can enable those surfaces to withstand imprints such as, but not limited to, the hard pressing of a thumbnail down into the surface or the pressure of an object. Current compositions (see, e.g., International Patent Publication WO2009/070293) do not perform satisfactorily. Furthermore, there is no available protective paint coating that will enable a surface to withstand indentation while remaining glossy and non-yellowing.

Thus, it may be beneficial to provide an exemplary hard clear coating and method for using the same which can overcome at least some of the deficiencies described herein above.

### SUMMARY OF EXEMPLARY EMBODIMENTS

According to an exemplary embodiment of the present disclosure, a coating composition capable of forming a hard clear protective paint coating is provided. The composition consists essentially of one or more aliphatic or aromatic polyisocyanates, or mixtures thereof, a solvent, and a catalyst. In certain exemplary embodiments, the composition does not comprise a resin, plastic, diol, polyester, or nanoparticles. In certain other exemplary embodiments, the composition comprises flattening agents, so as to reduce the gloss in the finish, or dyes or inks which do not include functional groups, such as hydroxyl, thiol, carboxylic acid, or amine groups which can react with isocyanate groups. In a particular exemplary embodiment, the polyisocyanate(s) can be the sole film-forming agent(s). The composition may further comprise, or further consist essentially of, a surface tension modifier, and/or a de-foaming agent. In one embodiment, the composition used to prepare the hard clear protective paint coating comprises the following ingredients: hexamethylene diisocyanate polyisocyanate; benzoic acid; N-butyl acetate; ethylene glycol butyl ether acetate; ethyl 3-ethoxy propionate; ethyl benzene; xylene; propylene glycol monomethyl ether acetate; and/or dibutyltin dilaurate.

In another exemplary embodiment of the present disclosure, a method is provided for applying a hard clear protective paint coating. The method comprises: removing moisture from compressed air, for example, by filtering compressed air to reduce moisture and impurities, and then applying the coating composition described herein to a surface, such as a painted surface using the filtered compressed air. In certain embodiments, the application is by spraying. Also in certain embodiments, the filtering to reduce moisture reduces the moisture to less than 85% of the moisture content in saturated air. The water content in 100% saturated air leaving a compressor is estimated to be approximately 0.62 10-2 kg per m³ free air (0.0062 kg water/m3 air). In certain exemplary embodiments, the impurities are removed by filtering using an activated charcoal filter. In a particular exemplary embodiment, the compressed air is filtered to reduce moisture and also filtered using an activated charcoal filter.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 shows a paint composite including translucent color layer with hard isolation coat and removable and replaceable topcoat on curved polished metal with translucent color and reflected light. As shown in the figure, layer 10 is a reapplied top coat. Layer 20 is the hard clear coat described herein. Layer 30 is a clear topcoat layer. Layer 40 is a translucent color layer. Layer 50 is an intermediate layer. Layer 60 is a layer of a clear primer. Layer 70 is a stainless steel substrate that is coated with layers 10, 20, 30, 40, 50 and 60. Reflected light is also shown.

FIG. 2 shows a paint composite including translucent color and solid or metallic layer with hard isolation coat and removable and replaceable topcoat on flat polished metal with translucent color and reflected light. Layer 1 is the substrate. Layer 2 is a clear primer/adhesion promoter. Layer 3 is an intermediate clear coat. Layer 4 is a translucent color, solid color, metallic color, or effect color. Layer 5 is a clear topcoat layer. Layer 6 is a coating as defined herein. Layer 7 is a topcoat layer. Reflected light is also shown, where light reflects off of the translucent layer and the substrate.

FIG. 3 shows a diagram of scratches in paint through to substrate, into paint, into clear, contrasted with scratches being minimized with the hard clear protective paint coating forming a hard isolation coat. On the left side, a deep scratch (80) is shown to pass through the clear coat layer (40), the basecoat color layer (50), the primer layer (60), and into the substrate (70). A paint scratch (90) passes through the clearcoat (40) and the basecoat color layer (50). A “clearcoat scratch” (100) only passes part-way through the clearcoat layer (40). In contrast, on the right side, the substrate includes two more coating layers, the coating layer described herein (30), and a clear coating layer (20). A deep scratch (80), only passes through the clear coating layer (20) and partway through the coating layer described herein (30), so does not scratch the substrate (70), or even pass through the clearcoat layer (40), the basecoat color layer (50), or the primer layer (60).

FIG. 4 shows a non-limiting example of the type of paintwork to which the hard clear protective paint coating has been applied.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

Exemplary embodiments of the present disclosure relate to a coating composition consisting essentially of one or more aliphatic or aromatic polyisocyanates, or mixtures thereof, a catalyst, and a solvent. The exemplary composition may be in liquid form. In certain embodiments, the composition does not comprise a resin, plastic, diol, polyester, or nanoparticles. In certain other exemplary embodiments, the composition comprises flattening agents, so as to reduce the gloss in the finish, or dyes or inks which do not include functional groups, such as hydroxyl, thiol, carboxylic acid, or amine groups which can react with isocyanate groups. In a particular embodiment, the polyisocyanate(s) are the sole film-forming agent(s). The exemplary composition may further comprise a surface tension modifier, and/or a de -foaming agent. In one exemplary embodiment, the hard clear protective paint coating comprises the following ingredients: hexamethylene diisocyanate polyisocyanate; benzoic acid; N-butyl acetate; ethylene glycol butyl ether acetate; ethyl 3-ethoxy propionate; ethyl benzene; xylene; propylene glycol monomethyl ether acetate; dibutyltin dilaurate.

The exemplary composition is capable of forming a hard clear protective paint coating. For example, when the composition is applied by a paint spray gun or by other means to a surface, it transforms via chemical reactions and evaporation to form an even, very hard, clear, non-yellowing, protective coating. The protective coating can operate as a final layer or other paint can be applied over the coating. The coating can be applied in such a way as to become an invisible layer and part of a paint composite, adding strength to the underlying layers and preventing damage to those underlying layers by creating a barrier to abrasion, indentation, chipping and scraping. The polyisocyanates described herein are applied to a surface in a composition that is essentially free of crosslinking agents, such as amines, thiols, or hydroxyl groups, so that the polyisocyanates are free to react with the moisture in ambient air in order to cure and form a hard clear protective coating. While not wishing to be bound to a particular theory, it is believed that water reacts with some of the isocyanate groups to form carbon dioxide and an amine, according to the equation RNCO+H₂O→RNH₂+CO₂, where R is the backbone of the polyisocyanate, and isocyanates react with amines to form ureas, according to the equation R₂NH+R′NCO→R₂NC(O)N(H)R′, where R is the backbone of the amine, and R′ is the backbone of the isocyanate. Accordingly, a polyisocyanate can react with water to form a polyamine, and the reaction between a di-isocyanate and a compound containing two or more amine groups produces long polymer chains known as polyureas. Ureas can also react with isocyanates to form biurets, which may also be present in the coating.

Some modes for carrying out various exemplary embodiments of the present disclosure are presented in terms of its aspects, herein discussed below. However, exemplary embodiments of the present disclosure is not limited to the described embodiment and a person skilled in the art will appreciate that many other embodiments of the present disclosure are possible without deviating from the basic concept of exemplary embodiments of the present disclosure, and that any such work around will also fall under scope of the present disclosure. It is envisioned that other styles and configurations of the present disclosure can be easily incorporated into the teachings of exemplary embodiments of the present disclosure, and only one particular configuration shall be shown and described for purposes of clarity and disclosure and not by way of limitation of scope.

Headings used herein are for organizational purposes only and are not meant to be used to limit the scope of the description or the enclosed paragraphs. As used throughout this application, the word “may” is used in a permissive sense (i.e., meaning having the potential to), rather than the mandatory sense (i.e., meaning must). The terms “a” and “an” herein do not denote a limitation of quantity, but rather denote the presence of at least one of the referenced items.

### Composition of the Hard Clear Protective Paint Coating

Exemplary embodiments of the present application provide a composition capable of forming a hard clear protective paint coating that unexpectedly provides outstanding protection for a painted surface from scratching and scarring while the surface maintains an attractive glossy, non-yellowing appearance. The hard clear protective paint coating disclosed herein is designed to go over a variety of substrates including, but not limited to: other, well-cured paint systems, plastics, metals, stone, marble, furniture, cars and car parts, airplanes and airplane parts, motorcycles and motorcycle parts, artwork, including paintings and sculptures, fiberglass, carbon fiber and carbon fiber-containing composite materials, fabrics, and glass.

The coating composition is visually a clear liquid, which is solvent-based, and in some embodiments has an odor similar to that of an ester. The composition dries at room temperature, although additives may be introduced to slow or speed the drying as desired. In some embodiments, the composition sufficiently cures, so that the next layer can be applied, within about one hour. The hard clear protective paint coating is invisible to the naked eye after application, but can still provide protection. The hard clear protective paint coating can be used locally on select areas as well as for spot repair of scratches, indentations and chips as an invisible filler. The hard clear protective coating can be sanded, cleaned and recoated numerous times. Any number of additional other coatings can be adhered over the top of the hard clear protective paint coating. In some embodiments, the hard clear protective paint coating does not contain a resin, plastic, diol, or polyester. The hard clear protective paint coating can be applied over complex three-dimensional objects or tight crevices. For example, the hard clear protective paint coating can be applied over polished stone/marble with translucent or with solid colors or without colors, and can include flatting agents to reduce the gloss.

In certain embodiments of the present disclosure, various isocyanates are blended with other ingredients, such as solvents and other additives. Isocyanates may be diisocyanates, which contain two isocyanate groups, and polyisocyanates, which are usually derived from diisocyanates and may contain several isocyanate groups. The diisocyanates and polyisocyanates can be aliphatic or aromatic, and can include blends of two or more aliphatic and/or aromatic diisocyanates or polyisocyanates. The term aliphatic as defined herein is a C₁₋₁₅ straight chain, cyclic, or branched alkyl moieties, and an aliphatic polyisocyanates preferably includes two or more isocyanate groups, preferably two to four isocyanate groups per molecule. The term aromatic is defined herein as a C₆ or a C₁₀ aromatic moiety, which optionally includes one, two, or three C₁₋₆ alkyl groups, and aromatic polyisocyanates preferably includes two or more isocyanate groups, preferably two to four isocyanate groups per molecule. Representative diisocyanates include, but are not limited to, methylenebis(phenyl isocyanate) (MDI), toluene diisocyanate (TDI), hexamethylene diisocyanate (HDI), naphthalene diisocyanate (NDI), methylene bis-cyclohexylisocyanate (HMDI)(hydrogenated MDI), and isophorone diisocyanate (IPDI). Examples of polyisocyanates include HDI biuret and HDI isocyanurate. Any of the diisocyanates or polyisocyanates can be in the form of a biuret (the reaction product of a urea and an isocyanate, according to the equation R₂NC(O)N(H)R′+R″NCO→R₂NC(O)NR′C(O)NHR″). In some embodiments, polyisocyanate oligomers are present, such as isocyanurate trimers of isocyanates, such as the isocyanurate trimer of TDI, HMDI or other such polyisocyanate oligomers. In preferred embodiments, the hard clear protective paint coating contains a diisocyanate, more preferably an aliphatic polyisocyanate, and most preferably polyhexamethylenediisocyanate.

In certain embodiments the wt/wt ratio of isocyanate to other components is either greater or less than 1:1, 1:2, 1:3, 1:4, 1:5, 1:6, 1:7, 1:8, 1:9, 1:10, 1:20, 1:30, 1:40, 1:50, 1:60, 1:70, 1:80, 1:90, 1:100. In other embodiments, the wt/wt percentage of isocyanate to other components is either greater or less than 1%, 2%, 3%, 4%, 5%, 6%, 7%, 8%, 9%, 10%, 20%, 30%, 40%, 50%, 60%, 70%, 80%, 90%, 100%. In further embodiments, the wt/wt percentage of isocyanate to other components may be in the range of 0.1-1%, 1-10%, 2-10%, 3-10%, 4-10%, 5-10%, 6-10%, 7-10%, 8-10%, 9-10%, 10-20%, 10-30%, 10-40%, 10-50%, 10-60%, 10-70%, 10-80%, 10-90%, 20-200%, 20-30%, 20-40%, 20-50%, 20-60%, 20-70%, 20-80%, 20-90%, 20-100%, 30-40%, 30-50%, 30-60%, 30-70%, 30-80%, 30-90%, 30-100%, 40-50%, 40-60%, 40-70%, 40-80%, 40-90%, 40-100%, 50-60%, 50-70%, 50-80%, 50-90%, 50-100%, 60-70%, 60-80%, 60-90%, 60-100%, 70-80%, 70-90%, 70-100%, 80-90%, 80-100%, 90-100%.

The primary ingredients in one exemplary embodiment of the hard clear protective paint coating are: Hexamethylene Diisocyanate Polyisocyanate (CAS Number: 28182-81-2; Linear formula C₈H₁₂N₂O₂); Benzoic Acid (CAS Number: 65-85-0; Linear formula C₆H₅COOH); N-Butyl Acetate (CAS Number: 123-86-2; Linear formula C₆H₁₂O₂); Ethylene Glycol Butyl Ether Acetate (CAS Number: 112-07-2; Linear formula C₈H₁₆O₃); Ethyl 3-Ethoxy Propionate (CAS Number: 763-69-9; Linear formula C₂H₅OCH₂CH₂CO₂C₂H₅); Ethyl Benzene (CAS Number: 100-41-4; Linear formula C₆H₅C₂H₅); Xylene (CAS Number: 1330-20-7; Linear formula C₆H₄(CH₃)₂); Propylene Glycol Monomethyl Ether Acetate (CAS Number: 108-65-6; Linear formula CH₃CO₂CH(CH₃)CH₂OCH₃); Dibutyltin dilaurate (CAS Number: 77-58-7; Linear formula (CH₃CH₂CH₂CH₂)₂Sn[OCO(CH₂)₁₀CH₃]₂); and optionally BYK 065 (a polysiloxane anti-foaming agent) and/or BYK 333.

Suitable additives may be any compound which will not interfere with the efficacy of the other components in the hard clear protective paint coating and which increases adhesion. Suitable additives include, but are not limited to, fillers, plasticizers, flattening agents, and stabilizers. Plasticizers, as known to those skilled in the art, may be used to enhance the composition's flow properties and flexibility once the components have cured. Suitable plasticizers may include polymeric resins, elastomers, waxes, oils, and combinations thereof. Stabilizers, as known to those skilled in the art, provide protection to coatings and light sensitive substrates. Preferred commercially available stabilizers include Tinuvin® 328 and Irganox® 245 produced by Ciba® Specialty Chemicals. Tinuvin® 328 is a UV absorber of the hydroxyphenylbenzotriazole class and Irganox® 245 is a sterically-hindered, phenolic antioxidant.

Suitable solvents may be Mineral spirits (US)/White spirit (UK), Acetone, Turpentine, Naphtha, Toluene, Methyl ethyl ketone (MEK), Dimethylformamide (DMF), 2-Butoxyethanol, or any of the other glycol ethers, Ethylbenzene, Xylene, n-butyl acetate and Butan-1-ol. While the amount of solvent may vary, in some embodiments, particularly where the formulation is to be applied using spray drying, the viscosity of the formulation is typically in the range of between about 20 and about 60 cps.

Suitable catalysts may comprise, for example, carboxylic acid metal salts, such as alkyl titanic acid salts, tin octylate, dibutyltin dilaurate, lead octylate, etc; sulfide type and mercaptide type organic tin compounds, such as monobutyltin sulfide, dibutyltin dioctyl mercaptide, etc; acidic accelerators, such as p-toluenesulfonic acid, phthalic acid, etc; amines, such as, tetraethylenepentamine, triethylenediamine, N-β-aminoethyl-γ-aminopropyltrimethoxysilane, etc; alkaline accelerators, such as potassium hydroxide, sodium hydroxide; and the like. In some embodiments, the catalysts do not include alkaline, amine, or acidic accelerators. In some embodiments, the catalyst is capable of catalyzing the reaction of one or more of the isocyanate groups in the one or more aliphatic or aromatic polyisocyanates with ambient water in the air to form one or more amine groups, and/or of catalyzing the reaction between one or more of the thus-formed amine groups with one or more isocyanate groups in the polyisocyanates.

### Exemplary Method of Applying the Hard Clear Protective Paint Coating

In particular exemplary embodiments of the present disclosure, the coating composition is sprayed onto a surface using compressed air that has a very low contaminant level. This compressed air is free of most moisture and oils from the compression of the air. The air is filtered through a refrigerated air dryer which drops 85% of the moisture out of the air and this is further reduced by use of an activated charcoal filter module (e.g. SATA filter 484).

In certain exemplary embodiments of the present disclosure, the hard clear protective paint coating is sprayed in a ventilated spraybooth, which in the winter warms the incoming air to a range of 18.3° C. to 25.55° C. In particular embodiments, the air is warmed to 93.3° C. to expedite the drying process. In the warmer months, the air may be filtered ambient air. The incoming air is filtered to approximately 9 micron regardless of season so that dust particles and below pass through only. Spraying can be conducted by compressed air spray tools such as, but not limited to, HVLP, conventional, or airless. One of ordinary skill will understand that the method and means of spraying is not limiting.

Other factors may also affect the consistency of the hardened paint product and/or the time taken for hardening to occur. These factors may include, but are not limited to, environmental factors such as atmospheric humidity, component factors such as hygroscopicity and/or water content of the polymer, and physical factors such as mixing time.

In certain exemplary embodiments of the present disclosure, the hard clear protective coating is used at lower film builds to provide greater inherent strength overall. The present formulation unexpectedly results in a hard clear protective paint coating with high durability and toughness while maintaining a high gloss appearance for the paint surface and non-yellowing appearance. The following examples are non-limiting and serve to provide further illustration of exemplary embodiments of the present disclosure.

### EXAMPLES

### Example 1: Manufacture

Portions of the components of the coating composition can be purchased as one liquid ingredient, which can, in some embodiments, be stored in an airtight metal can with a plastic threaded lid. The other ingredients can be, for example, stored separately, for example, in glass containers with a threaded plastic lid and poured, measuring by weight on a gram scale to combine prior to use. One of skill in the art can purchase the raw ingredients and store all or part of the ingredients separately. One of skill in the art can combine all ingredients and store them in one container provided that no moisture is introduced into the can and replace the air in the container with a gas, such as nitrogen, that would prevent gelation.

In one embodiment, the components can be mixed slowly with a clean dry metal stir stick in a clean dry container to avoid introducing air and moisture while mixing. In one embodiment (denoted herein as “HC4”), BASF Glasurit 929-91 Hardener (which includes (by wt %) 1.0-3.0 benzoic acid, 0.1-0.2% dibutyltin dilaurate, 1.0-3.0% ethylbenzene, 10.0-15.0% 4-methylpentan-2-one, 1.0-3.0% 1-methoxy-2-propylacetate, 10.0-15.0% isobutyl acetate, 20.0-25.0% n-butyl acetate, 7.0-10.0% xylene, and 25.0-50.0% hexamethylene diisocyanate isocyanurate-type oligomers), and BYK 333 (a polyether modified polydimethylsiloxane) are mixed as follows:

The materials are measured by weight. The Glasurit 929-91 is poured out at 200 Grams and the BYK 333® is poured out at 0.30 grams. The components are poured into a plastic cup and mixed with a clean plastic stir stick for several minutes. This composite is mixed at room temperature and poured through a strainer 200 microns. The hard clear protective paint coating typically has a pot life that is equal to one typical work shift in relation to an industrial spray paint.

### Example 2: Exemplary Application

In tests, HC4 was sprayed immediately with a 3M accuspray 1.4 nozzle at 22 psi in one coat to assess the quality of the surface after coating. HC4 was sprayed again two hours later the same way. HC4 was then sprayed again five hours later. A new batch of HC4 was then made and sprayed immediately eight hours after the initial application. Four layers total were tested in for this round of tests.

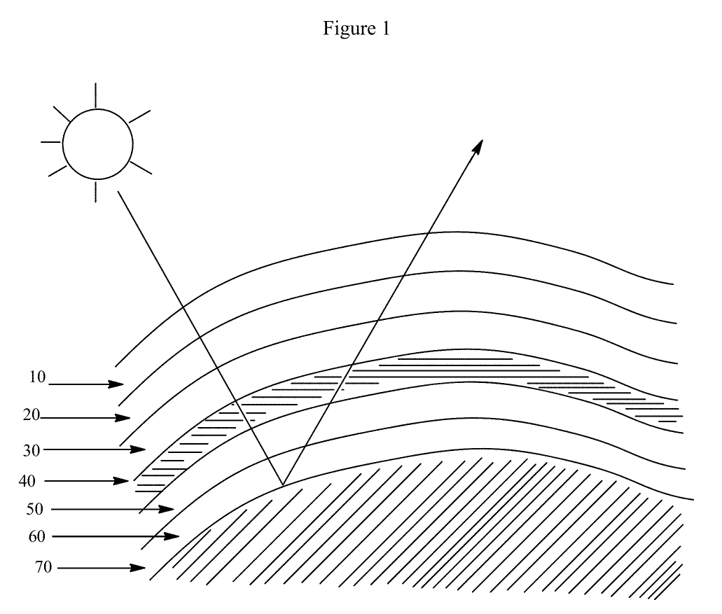

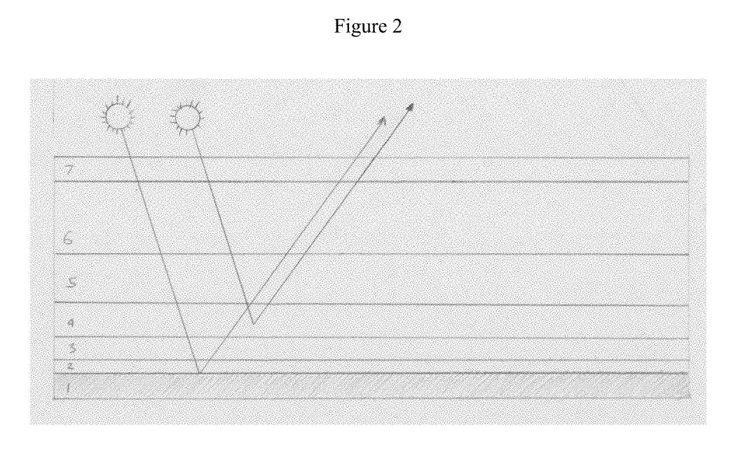

In further embodiments, the surface of the coating is sanded and then three more layers are applied to achieve a high film build without an adverse reaction (see, e.g., FIGS. 1 and 2). In other embodiments a couple more layers are sprayed wet with long flash off times.

The hard clear protective paint coating is sprayed on a variety of surfaces to verify compatibility. The hard clear protective paint coating is applied to conform to the underlying surface.

The dry film thickness of the hard clear protective paint coating may be in a range from as low as 4 dry mils to 40 mils (depending on what is required to produce the desired level of durability). In certain embodiments, the hard clear protective paint coating is applied at 3-4 wet mils per layer. Sanding and cleaning between layers can be performed if the coating is dried to the touch.

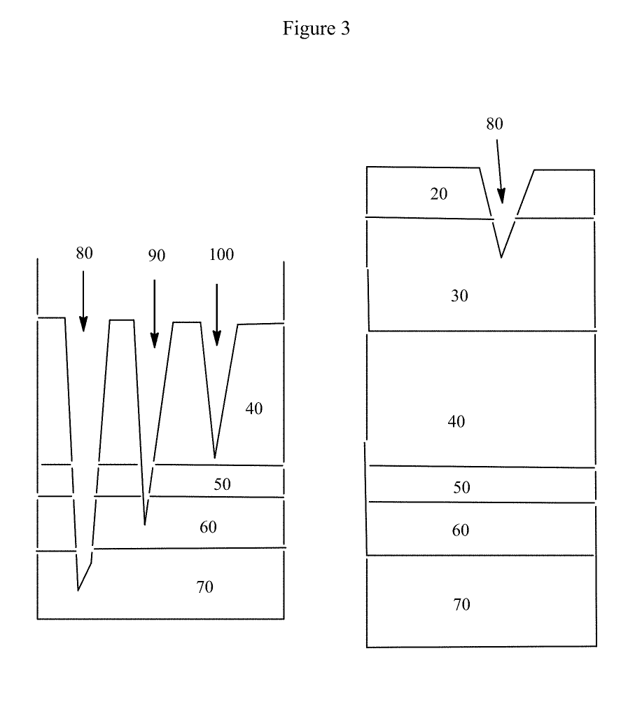

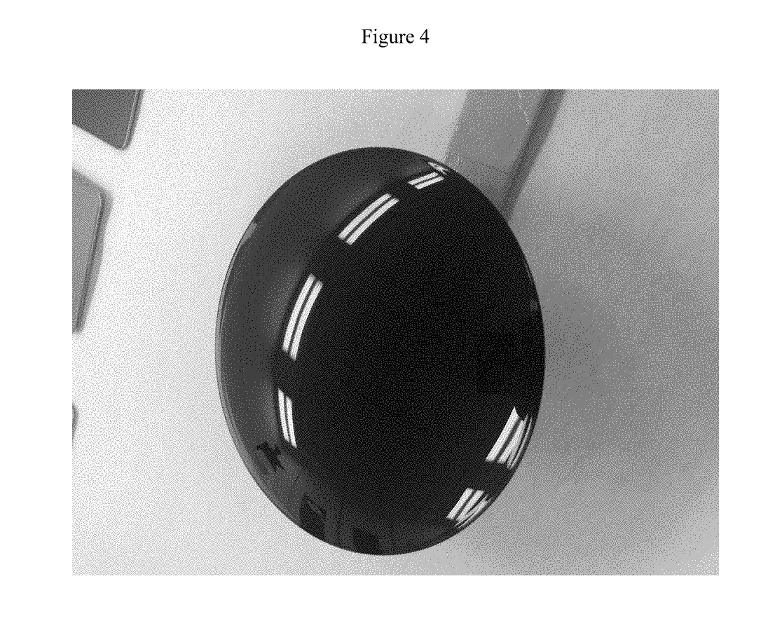

The problem of aesthetic deformation and damage of a paint coating and/or underlying material is solved by the successful spray application of the hard clear protective paint coating disclosed herein being applied over the paint coating and/or underlying material as a very hard isolation coat (see FIG. 3). The hard clear protective paint coating is applied in a manner in which it may appear invisible to the naked eye, because it is clear and does not change the underlying material (see FIG. 4). The hard protective layer formed is a sacrificial layer to take the abuse and is reshaped and reapplied for the continued protection of the valuable paint work and or underlying substrate.

### Example 3: Exemplary Optimization

In certain exemplary embodiments of the present disclosure, the following isocyanate ingredients are mixed individually or in combination with other hardeners and/or other additives:

Cyclohexane, 5-isocyanato-1-(isocyanatomethyl)-1,3,3-trimethyl-, homopolymer;

Hexane, 1,6-diisocyanato-, homopolymer;

Poly(hexamethylene diisocyanate) (CAS NO. 28182-81-2) (hexamethylene diisocyanate, oligomers).

In one exemplary embodiment of the present disclosure, a reactive reducer, such as PPG Reactive Reducers, can be mixed into 25% wt/wt or less isocyanate ingredients. In another embodiment, BASF Reactive Reducers are mixed into 25% wt/wt or less isocyanate ingredients. Reactive reducers have solvent power and permit application of polyisocyanate formulations with relatively high solids contents. In some embodiments, the solvents evaporate relatively quickly, and allow the compositions to be used with spray applications.

In a further exemplary embodiments of the present disclosure, a PPG Hardener DU6 mixture comprises: hexamethylene diisocyanate, oligomers; heptan-2-one; 3-Isocyanatomethyl -3,5,5-trimethylcyclohexyl isocyanate, oligomers; naphtha (petroleum), light aromatic; n-butyl acetate; 1,2,4-trimethylbenzene 3-isocyanatomethyl-3,5,5-trimethylcyclohexyl isocyanate.

In another embodiment, a PPG Hardener DX57 mixture comprises: hexamethylene diisocyanate, oligomers; 4-methylpentan-2-one; hexamethylene-di-isocyanate (CAS numbers 28182-81-2, 108-10-1, 822-06-0).

In various exemplary embodiments of the present disclosure, the DU6 and/or DX57 mixtures are mixed with 10-30% wt/wt or less isocyanate ingredients. In some embodiments, the hardener mixtures may be used alone. In other embodiments, the hardener mixtures may be mixed with 0.1-1% wt/wt or less isocyanate ingredients.

In further embodiments, paint brand hardeners used in the hard clear protective paint coating are PPG, BASF AXALTA, SIKKENS, AKZO-NOBEL, HOUSE OF COLOR, MATTHEWS PAINT COMPANY, LECHLER Hardeners and mixtures thereof.

The hard clear protective coating is tested for viscosity, hardness abrasion and impact resistance, adhesion testing.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the knowledge in the art, or in cited references herein, has not been explicitly incorporated by reference above, it is explicitly incorporated in its entirety.

What is claimed is:

1. A coating composition consisting essentially of:
one or more aliphatic polyisocyanates, aromatic polyisocyanates, or mixtures thereof;
one or more solvents; and
one or more catalysts which are capable of a) catalyzing the reaction of one or more of the isocyanate groups in the one or more aliphatic or aromatic polyisocyanates with ambient water in the air to form one or more amine groups, and/or b) catalyzing the reaction between one or more of the thus-formed amine groups with one or more isocyanate groups in the polyisocyanates.

2. The composition of claim 1, wherein the aliphatic polyisocyanate or the mixtures thereof are the sole film forming agent(s).

3. The composition of claim 1, wherein the composition excludes a resin, plastic, diol, polyester, or nanoparticles.

4. The composition of claim 1, further comprising at least one of a surface tension modifier, a de -foaming agent, a dye or ink which does not include reactive groups capable of reacting with a polyisocyanate, and a flattening agent.

5. The composition of claim 1, consisting essentially of: hexamethylene diisocyanate polyisocyanate; benzoic acid; N-butyl acetate; ethylene glycol butyl ether acetate; ethyl 3-ethoxy propionate; ethyl benzene; xylene; propylene glycol monomethyl ether acetate; dibutyltin dilaurate.

6. The composition of claim 1, wherein the viscosity of the composition is between about 20 and about 60 cps.

7. A method of applying a hard clear protective paint coating, comprising:
drying compressed air to reduce moisture; and
applying the coating composition of claim 1 to a surface using the dried compressed air.

8. The method of claim 7, wherein the moisture content in the air is reduced to less than 85% of the moisture content of saturated air.

9. The method of claim 7 wherein the drying step comprises filtering.

10. The method of claim 9, wherein the filtering also reduces impurities in the compressed air.

11. The method of claim 10, wherein the filtering is carried out using an activated charcoal filter.

12. The method of claim 7, wherein the composition is applied by spraying.

13. The method of claim 7, wherein the surface is a painted surface.

14. The method of claim 7, wherein the surface is selected from the group consisting of well -cured paint systems, plastics, metals, stone, marble, furniture, cars, parts, airplanes, airplane parts, motorcycles, motorcycle parts, artwork, fiberglass, carbon fiber, carbon fiber-containing composite materials, fabrics, and glass.

15. The method of claim 7, further comprising:
filtering compressed air to a moisture content of less than 85% of the moisture content of saturated air;
further filtering the compressed air using an activated charcoal filter; and
spraying the coating composition onto a surface.
